(19) United States
(12) Patent Application Publication
(10) Pub. No.: US 2016/0337929 A1
(43) Pub. Date: Nov. 17, 2016

(54) METHOD AND APPARATUS FOR FACILITATING AN ACCESS NETWORK CHANGE

(71) Applicant: NOKIA CORPORATION, Espoo (FI)

(72) Inventors: Jussi-Pekka KOSKINEN, Oulu (FI); Jarkko KOSKELA, Oulu (FI)

(21) Appl. No.: 15/110,049

(22) PCT Filed: Jan. 27, 2015
(86) PCT No.: PCT/FI2015/050053

§ 371 Date: Jul. 6, 2016

Related U.S. Application Data
(60) Provisional application No. 61/933,557, filed on Jan. 30, 2014.

(51) Int. Cl. H04W 36/30; H04L 29/06; H04W 72/04; H04L 12/801

(52) U.S. Cl. CPC H04W 36/30; H04L 47/29; H04L 69/28; H04W 72/0473; H04W 72/0486

(57) ABSTRACT

Methods, apparatus and computer program products are provided for facilitating smooth access network change. An example method for use in an access point or station may comprise receiving threshold values related to a particular parameter in a first access network and a second access network, respectively, causing measurement of a current value of the particular parameter in the first access network and the second access network, in an instance in which a condition exists where the thresholds are satisfied, determining if the condition is met for a predetermined amount of time, and in an instance in which the condition is met for the predetermined amount of time, determining if a previous access network change was outside a predefined time period, and in an instance in which the previous network change was outside the predefined time period, causing the access network change.

### TECHNOLOGICAL FIELD

Embodiments of the present invention relate generally to a method, apparatus, and computer program product for facilitating an access network change.

### BACKGROUND

Wireless communication is becoming more widespread as a continually increasing number of users acquire and place into operation ever-greater numbers of mobile communication devices. While cellular coverage is complemented by wireless local area network (WLAN) deployments, frequent changes between access networks may result in loss of data. Consequently, a need exists for a method to allow for access network changes in an effort to maximize utility offered by the multiple network opportunities, while still preserving efficient transmission of data.

### BRIEF SUMMARY

A method, apparatus and computer program product are therefore provided according to an example embodiment of the present invention for facilitating an access network change.

In some embodiments, a method may be provided, the method comprising receiving indication of a first threshold value and a second threshold value, the first threshold value and the second threshold value configured to indicate threshold values of a particular parameter in a first access network and a second access network, respectively, causing measurement of a current value of the particular parameter in the first access network and the second access network, the current value of the particular parameter in the first access network being a first parameter value and the current value of the particular parameter in the second access network being a second parameter value, in an instance in which a condition exists where the first parameter value satisfies the first threshold value and the second parameter value satisfies the second threshold value, determining if the condition is met for a predetermined amount of time, and in an instance in which the condition is met for the predetermined amount of time, causing an access network change.

In some embodiments, the method may further comprise, subsequent to causing an access network change, determining if a previous access network change was outside a predefined time period, and in an instance in which the previous network change was outside the predefined time period, causing the access network change. In some embodiments, the method may further comprise in an instance in which the previous network change was not outside the predefined time period, causing prevention of the access network change. In some embodiments, the particular parameter is one of power, load, resource allocation, or radio access network (RAN) thresholds.

In some embodiments, a method may be provided, the method comprising receiving indication of a single threshold value, the single threshold value configured to indicate a threshold value of a particular parameter in a first access network or a second access network, causing measurement of a current value of the particular parameter in one of the first access network or the second access network, in an instance in which a condition exists where the current value of the particular parameter satisfies the single threshold value, determining if the condition is met for a predetermined amount of time, and in an instance in which the condition is met for the predetermined amount of time, causing an access network change.

In some embodiments, the method may further comprise in an instance in which a user equipment (UE) is operating on the first access network, causing the measurement in the second access network, and in an instance in which the UE is operating on the second access network, causing the measurement in the second access network. In some embodiments, the method may further comprise receiving an indication of one of an onloading condition or an offloading condition, wherein in an instance in which a UE is operating on the first access network and the offloading condition is received, causing the measurement in the second access network. In some embodiments, the method may further comprise receiving an indication of one of an onloading condition or an offloading condition, wherein in an instance in which a UE is operating on the second access network and the onloading condition is received, causing the measurement in the first access network. In some embodiments, the particular parameter is one of power, load, resource allocation, or radio access network (RAN) thresholds. In some embodiments, the method may further comprise subsequent to causing an access network change, determining if a previous access network change was outside a predefined time period, in an instance in which the previous network change was outside the predefined time period, causing the access network change, and in an instance in which the previous network change was not outside the predefined time period, causing prevention of the access network change.

In some embodiments, a computer program product may be provided comprising at least one computer-readable storage medium having computer-executable program code instructions stored therein, the computer-executable program code instructions comprising program code instructions for receiving indication of a first threshold value and a second threshold value, the first threshold value and the second threshold value configured to indicate threshold values of a particular parameter in a first access network and a second access network, respectively, causing measurement of a current value of the particular parameter in the first access network and the second access network, the current value of the particular parameter in the first access network being a first parameter value and the current value of the particular parameter in the second access network being a second parameter value, in an instance in which a condition exists where the first parameter value satisfies the first threshold value and the second parameter value satisfies the second threshold value, determining if the condition is met for a predetermined amount of time, and in an instance in which the condition is met for the predetermined amount of time, causing an access network change.

In some embodiments, the computer-executable program code instructions further comprise program code instructions for subsequent to causing an access network change, determining if a previous access network change was outside a predefined time period, and in an instance in which the previous network change was outside the predefined time period, causing the access network change. In some embodiments, the computer-executable program code instructions further comprise program code instructions for in an instance in which the previous network change was not outside the predefined time period, causing prevention of the access network change. In some embodiments, the particular parameter is one of power, load, resource allocation, or radio access network (RAN) thresholds.

In some embodiments, a computer program product may be provided comprising at least one computer-readable storage medium having computer-executable program code instructions stored therein, the computer-executable program code instructions comprising program code instructions for receiving indication of a single threshold value, the single threshold value configured to indicate a threshold value of a particular parameter in a first access network or a second access network, causing measurement of a current value of the particular parameter in one of the first access network or the second access network, in an instance in which a condition exists where the current value of the particular parameter satisfies the single threshold value, determining if the condition is met for a predetermined amount of time, and in an instance in which the condition is met for the predetermined amount of time, causing an access network change.

In some embodiments, the computer-executable program code instructions further comprise program code instructions for in an instance in which a UE is operating on the first access network, causing the measurement in the second access network, and in an instance in which a UE is operating on the second access network, causing the measurement in the second access network. In some embodiments, the computer-executable program code instructions further comprise program code instructions for receiving an indication of one of an onloading condition or an offloading condition, wherein in an instance in which a UE is operating on the first access network and the offloading condition is received, causing the measurement in the second access network. In some embodiments, the computer-executable program code instructions further comprise program code instructions for receiving an indication of one of an onloading condition or an offloading condition, wherein in an instance in which a UE is operating on the second access network and the onloading condition is received, causing the measurement in the first access network. In some embodiments, the particular parameter is one of power, load, resource allocation, or radio access network (RAN) thresholds. In some embodiments, the computer-executable program code instructions further comprise program code instructions for subsequent to causing an access network change, determining if a previous access network change was outside a predefined time period, in an instance in which the previous network change was outside the predefined time period, causing the access network change, and in an instance in which the previous network change was not outside the predefined time period, causing prevention of the access network change.

In some embodiments, an apparatus may be provided comprising at least one processor and at least one memory including computer program code, the at least one memory and the computer program code configured to, with the processor, cause the apparatus to at least receive indication of a first threshold value and a second threshold value, the first threshold value and the second threshold value configured to indicate threshold values of a particular parameter in a first access network and a second access network, respectively, cause measurement of a current value of the particular parameter in the first access network and the second access network, the current value of the particular parameter in the first access network being a first parameter value and the current value of the particular parameter in the second access network being a second parameter value, in an instance in which a condition exists where the first parameter value satisfies the first threshold value and the second parameter value satisfies the second threshold value, determine if the condition is met for a predetermined amount of time, and in an instance in which the condition is met for the predetermined amount of time, cause an access network change.

In some embodiments, the at least one memory and the computer program code are further configured to, with the processor, cause the apparatus to subsequent to causing an access network change, determine if a previous access network change was outside a predefined time period, and in an instance in which the previous network change was outside the predefined time period, cause the access network change. In some embodiments, the at least one memory and the computer program code are further configured to, with the processor, cause the apparatus to in an instance in which the previous network change was not outside the predefined time period, cause prevention of the access network change. In some embodiments, the particular parameter is one of power, load, resource allocation, or radio access network (RAN) thresholds.

In some embodiments, an apparatus may be provided comprising at least one processor and at least one memory including computer program code, the at least one memory and the computer program code configured to, with the processor, cause the apparatus to at least receive indication of a single threshold value, the single threshold value configured to indicate a threshold value of a particular parameter in a first access network or a second access network, cause measurement of a current value of the particular parameter in one of the first access network or the second access network, in an instance in which a condition exists where the current value of the particular parameter satisfies the single threshold value, determine if the condition is met for a predetermined amount of time, and in an instance in which the condition is met for the predetermined amount of time, cause an access network change.

In some embodiments, the at least one memory and the computer program code are further configured to, with the processor, cause the apparatus to in an instance in which a UE is operating on the first access network, cause the measurement in the second access network, and in an instance in which a UE is operating on the second access network, cause the measurement in the second access network. In some embodiments, the at least one memory and the computer program code are further configured to, with the processor, cause the apparatus to receive an indication of one of an onloading condition or an offloading condition, wherein in an instance in which a UE is operating on the first access network and the offloading condition is received, cause the measurement in the second access network. In some embodiments, the at least one memory and the computer program code are further configured to, with the processor, cause the apparatus to receive an indication of one of an onloading condition or an offloading condition, wherein in an instance in which a UE is operating on the second access network and the onloading condition is received, cause the measurement in the first access network. In some embodiments, the particular parameter is one of power, load, resource allocation, or radio access network (RAN) thresholds. In some embodiments, the at least one memory and the computer program code are further configured to, with the processor, cause the apparatus to subsequent to causing an access network change, determine if a previous access network change was outside a predefined time period, in an instance in which the previous network change was outside the predefined time period, cause the access network change, and in an instance in which the previous network change was not outside the predefined time period, cause prevention of the access network change.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is an example flowchart illustrating a method of operating an example apparatus in accordance with an embodiment of the present invention.

FIG. 4 is an example flowchart illustrating a method of operating an example apparatus in accordance with an embodiment of the present invention;

FIG. 5 is an example flowchart illustrating a method of operating an example apparatus in accordance with an embodiment of the present invention; and

FIG. 6 is an example flowchart illustrating a method of operating an example apparatus in accordance with an embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

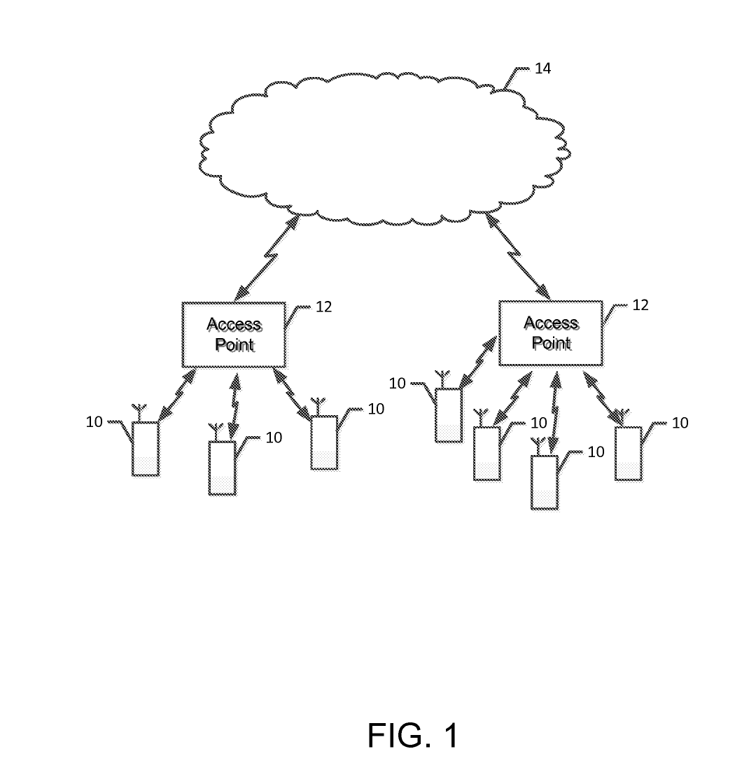

Referring now to FIG. 1, which illustrates an example system that supports communications between a plurality of stations 10 and one or more access points 12, each access point may communicate with one or more stations and, in one embodiment, may communicate with a large number of stations, such as 6,000 or more stations. The access points may, in turn, communicate with a network 14. While the access points may communicate via an Long Term Evolution (LTE) or LTE-Advanced (LTE-A) network, other networks may support communications between the access points including those configured in accordance with wideband code division multiple access (W-CDMA), CDMA2000, global system for mobile communications (GSM), general packet radio service (GPRS), the IEEE 802.11 standard including, for example, the IEEE 802.11 ah or 802.11 ac standard or other newer amendments of the standard, wireless local access network (WLAN), Worldwide Interoperability for Microwave Access (WiMAX) protocols, universal mobile telecommunications systems (UMTS) terrestrial radio access network (UTRAN) and/or the like.

The access points 12 and the stations 10 may communicate via wireline communications, but most commonly communicate via wireless communications. For example, the access points and the stations may communicate in a sub 1 GHz band as defined by IEEE 802.11ah standard or in a 5 GHz band, which may be defined by, for example, IEEE 802.11ac standard. The access point may be embodied by any of a variety of network entities, such as an access point, a base station, a Node B, an evolved Node B (eNB), a radio network controller (RNC), a mobile device (e.g., mobile telephones, smart phones, portable digital assistants (PDAs), pagers, laptop computers, tablet computers or any of numerous other hand held or portable communication devices, computation devices, content generation devices, content consumption devices, or combinations thereof), or the like. The stations may also be embodied by a variety of devices, such as sensors, meters or the like. The sensors and meters may be deployed in a variety of different applications including in utility applications to serve as a gas meter, a water meter, a power meter or the like, in environmental and/or agricultural monitoring applications, in industrial process automation applications, in healthcare and fitness applications, in building automation and control applications and/or in temperature sensing applications, to name but a few. Stations that are embodied by sensors or meters may be utilized in some embodiments to backhaul sensor and meter data. Alternatively, the stations may be embodied by mobile terminals or user equipment(s) (UE), such as mobile communication devices, e.g., mobile telephones, smart phones, portable digital assistants (PDAs), pagers, laptop computers, tablet computers or any of numerous other hand held or portable communication devices, computation devices, content generation devices, content consumption devices, or combinations thereof. In an embodiment in which the station is embodied by a mobile terminal, the communication between an access point and the station may serve to extend the range of Wi-Fi or another wireless local area network (WLAN), such as by extending the range of a hotspot, and to offload traffic that otherwise would be carried by a cellular or other network.

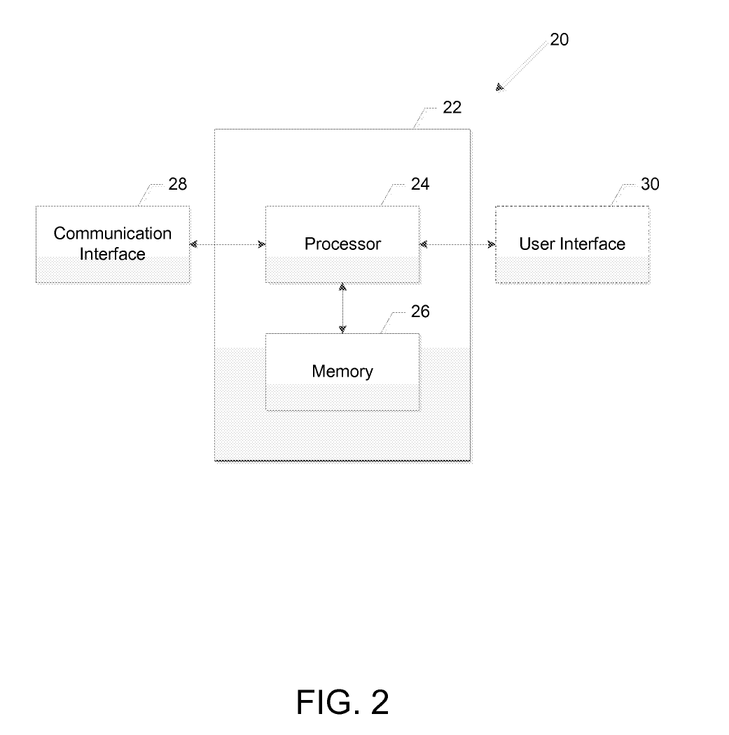

The access point 12 and/or the station 10 may be embodied as or otherwise include an apparatus 20 that is specifically configured to perform the functions of the respective device, as generically represented by the block diagram of FIG. 2. While the apparatus may be employed, for example, by an access point or a station, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution, signal processing, measurements and report generation, and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein. Alternatively or additionally, a processing system may be embodied by or have similar functionality to the processing circuitry.

In an example embodiment, the processing circuitry 22 may include a processor 24 and memory 26 that may be in communication with or otherwise control a communication interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments, the processing circuitry may be embodied as a portion of the mobile terminal 10.

The user interface 30 (if implemented) may be in communication with the processing circuitry 22 to receive an indication of a user input at the user interface and/or to provide an audible, visual, mechanical or other output to the user. In this regard, the user interface and/or the processing circuitry 22 may include user interface circuitry configured to facilitate user control of at least some functions based upon user input. The user interface may include, for example, a keyboard, a mouse, a trackball, a display, a touch screen, a microphone, a speaker, and/or other input/output mechanisms. The apparatus 20 need not always include a user interface.

The communication interface 28 may include one or more interface mechanisms for enabling communication with other devices and/or networks, such as for enabling communication between an access point 12 and a station 10 or between two or more stations. In some cases, the communication interface may be any means such as a device or circuitry embodied in either hardware, or a combination of hardware and software that is configured to receive and/or transmit data from/to a network and/or any other device or module in communication with the processing circuitry 22. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory may be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an application specific integrated circuit (ASIC), an field programmable gate array (FPGA), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

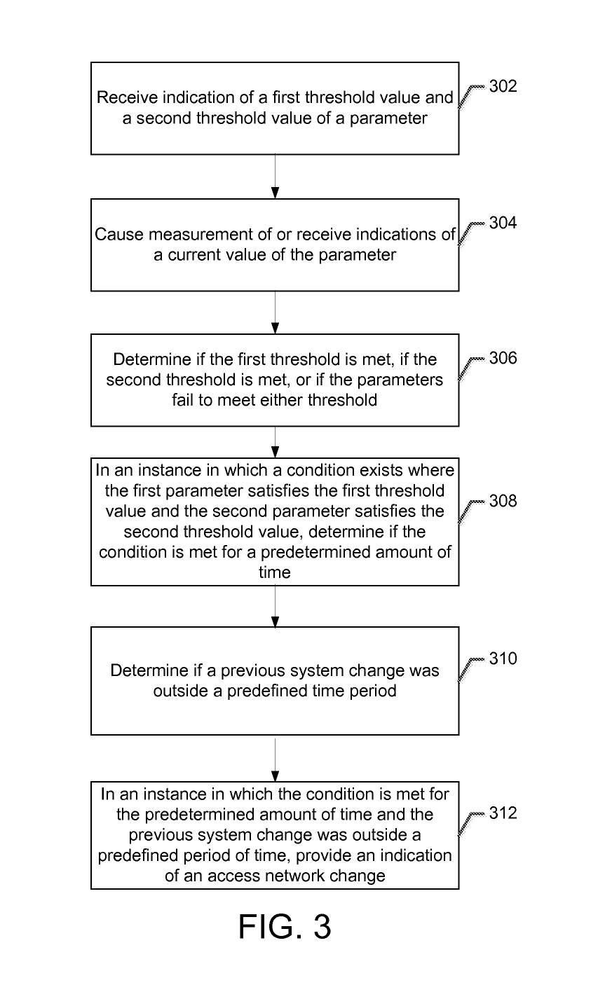

FIGS. 3, 4, 5, and 6 illustrate an example flowchart of the example operations performed by a method, apparatus and computer program product in accordance with an embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 3, 4, 5, and 6, when executed, convert a computer or processing circuitry into a particular machine configured to perform an example embodiment of the present invention. Accordingly, the operations of FIGS. 3, 4, 5, and 6 define an algorithm for configuring a computer or processing to perform an example embodiment. In some cases, a general purpose computer may be provided with an instance of the processor which performs the algorithms of FIGS. 3, 4, 5, and 6 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

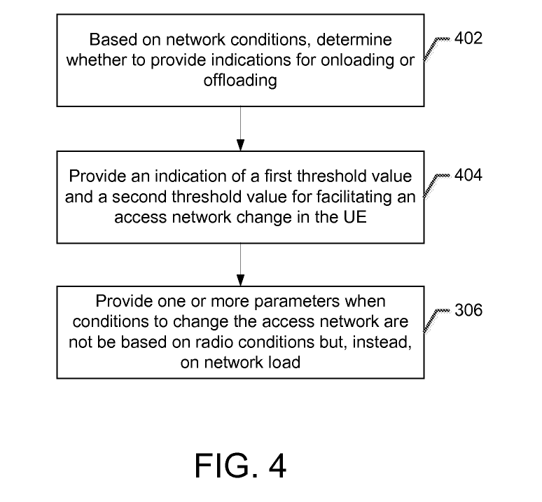

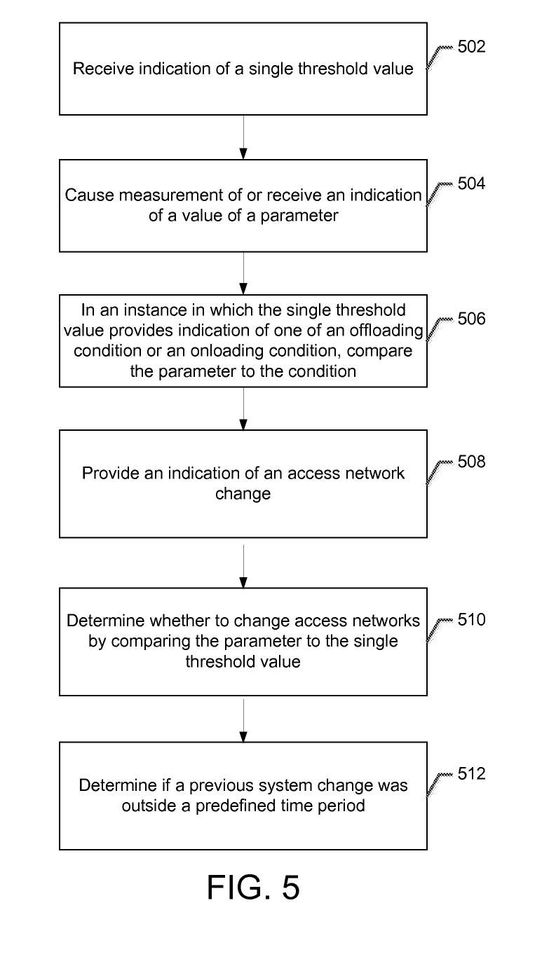

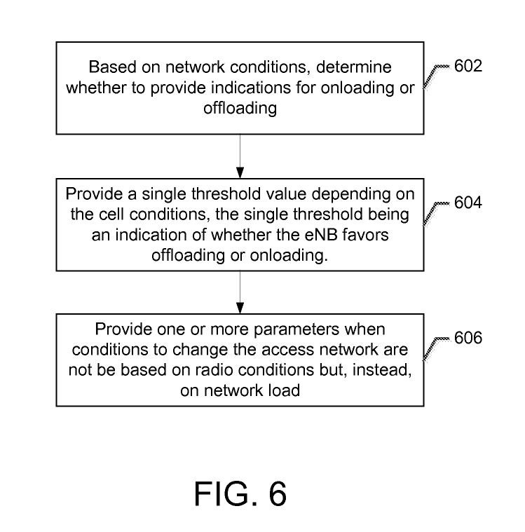

In some example embodiments, a method, apparatus and computer program product are provided for facilitating an access network change. Two different system embodiments exist which may be used to facilitate a change in an access network. FIGS. 3 and 4 show processes that may be performed by a UE and by an eNB, respectively, in the first system embodiment. FIGS. 5 and 6 then show processes that may be performed by a UE and an eNB, respectively, in the second system embodiment.

In a first system embodiment, an eNB may provide a UE with two threshold values, a first threshold and second threshold. The UE may be configured to then utilize one or both thresholds for determining if, for example, measured parameters indicate that an access network change is required. As such, FIG. 3 shows an example process that may, in some embodiments, be executed by a UE while FIG. 4 shows an example process that may, in some embodiments, be executed by an example eNB. The exemplary processes shown below allow various embodiments of the present invention to facilitate an access network change where two threshold values are provided. Returning back to FIG. 3, the operations performed by an apparatus 20, such as illustrated in FIG. 2, embodied by a UE are illustrated and will be hereinafter described.

A shown in block 302 of FIG. 3, the apparatus may include means, such as the processing circuitry 22, the processor 24, the communication interface 28 or the like, for receiving an indication of a first threshold value and a second threshold value. The first threshold value may be a value associated with a particular parameter of a first access network, for example, power or a power ratio. The second threshold may be indicative of a value of the particular parameter for a second access network. For example, the UE may be configured to receive threshold values related to power. In some embodiments, any of a plurality of parameters may be utilized, such as for example, load information (e.g., a direct/indirect indication of Universal Mobile Telecommunications System (UMTS)/LTE load, e.g. in percentage, in load levels (low, medium, high) or offload preference indicator), resource allocation (e.g., a maximum resource allocation the UE may receive on UMTS/LTE), WLAN thresholds (e.g., WLAN received signal strength indicator (RSSI) threshold, WLAN basic service set (BSS) load threshold and WLAN wide area network (WAN) metric threshold), or RAN thresholds (e.g., Reference Signal Received Power (RSRP)/received signal code power (RSCP) thresholds).

In an example embodiment, the UE, operating in, for example, a 3GPP connected mode and configured such that in order to route traffic from a cellular network to WLAN, thresholds indicating power levels are received. Accordingly, the first threshold may be a 3GPP RSRP threshold, which may be set to <−90 dBm. The second threshold may be a WLAN RSSI threshold, which may be set to >−80 dBm. Here, the first threshold may be utilized as a maximum threshold, such that a condition indicating the first threshold is met when a current value is less than the first threshold value. The second threshold may be utilized as a minimum threshold, where a condition indicating that the second threshold is met when a current value is greater than or equal to the second threshold value.

Referring now to block 304 of FIG. 3, the apparatus may include means, such as the processing circuitry 22, the processor 24, the communication interface 28 or the like, for causing measurement of a current value of a parameter in one or both of the first access network or the second access network. For example, the 3GPP RSRP may be measured at −86 dBm or the current value of the WLAN RSSI may be measured at −80 dBm. For clarity, the current value in the first access network will be referred to a first parameter value and the current value in the second access network will be referred to as the second parameter value.

In another embodiment, the first parameter value and/or the second parameter value (as described above as the current value of the parameter in the access networks), or an indication of a value related thereto, may be received from, for example, an eNB. As such, the apparatus may include means, such as the processing circuitry 22, the processor 24, the communication interface 28 or the like, for receiving an indication of the current value of the parameter. For example, this may be the case when conditions to change the access network may not be based on radio conditions but instead, for example, on load in the system and thus parameters may not actually be traditional radio measurements but information provided by the network (NW). In another example embodiment, this information may be priority/preference of NW selection, such as for example, which network the UE should use for data transmissions.

As shown in block 306 of FIG. 3, the apparatus may include means, such as the processing circuitry 22, the processor 24, the communication interface 28 or the like, for determining if the first parameter satisfies the first threshold, if the second parameter satisfies the second threshold, or if the parameters fail to meet either threshold. For example, the UE may measure 3GPP RSRP to be less than, more than or equal to −90 dBm and WLAN RSSI to be less than, more than or equal to −80 dBm. In an instance in which the UE measures 3GPP RSRP to be less than −90 dBm and WLAN RSSI to be more than −80 dBm, the UE may determine that the first parameter satisfies the first threshold value and the second parameter satisfies the second threshold value.

As shown in block 308 of FIG. 3, the apparatus may include means, such as the processing circuitry 22, the processor 24, the communication interface 28 or the like, for, in an instance in which a condition exists where the first parameter satisfies the first threshold value and the second parameter satisfies the second threshold value, determining if the condition is met for a predetermined amount of time. For example, in one embodiment, the UE may require that the conditions be met for 2 seconds. As such, in an instance in which, as above, the UE measures 3GPP RSRP to be less than −90 dBm and WLAN RSSI to be more than −80 dBm during 1.5 seconds, the UE may start a margin time. But when the 3GPP RSRP increases to more than −90 dBm, the UE may then stop the margin timer.

Referring now to block 312 of FIG. 3, the apparatus may include means, such as the processing circuitry 22, the processor 24, the communication interface 28 or the like, for, in an instance in which the condition is met for the predetermined amount of time, cause a network access change. For example, when the UE measures 3GPP RSRP to be less than −90 dBm and WLAN RSSI to be more than −80 dBm for 2 seconds, an indication may be provided by, for example, lower layers to upper layers indicating an access network change should be performed. In another embodiment, lower layers may be configured to provide the measurement results for upper layers and upper layers may perform the comparisons. In another embodiment, the WLAN radio could indicate separately that WLAN fulfills the condition and 3GPP radio does similarly for the 3GPP radio condition. As such, whichever UE layer determines which traffic goes to WLAN or 3GPP, then routes the traffic based on the thresholds and parameter measurements.

Additionally or alternatively, in order to avoid frequent access network changes and possible loss of data, access network changes during transmission should be limited. As such, the apparatus may include means, such as the processing circuitry 22, the processor 24, the communication interface 28 or the like, for, as shown in block 310, determining if a previous system change was been outside a predefined time period, such as for example, 3 seconds ago. In an instance in which the previous network change was outside the predefined time period, the processing circuitry 22, the processor 24, the communication interface 28 or the like may be configured for causing the access network change. In an instance in which the previous network change was not outside the predefined time period, the processing circuitry 22, the processor 24, the communication interface 28 or the like may be configured for causing prevention of the access network change.

Referring now to FIG. 4, a flow chart is shown illustrating operations performed by the apparatus 20, such as shown in FIG. 2, embodied by an access point 12 or station 10, in accordance with an example embodiment of the present invention. The operations performed by an apparatus 20, such as illustrated in FIG. 2, embodied by an access point 12 or station 10 will be hereinafter described. Referring now to block 402 of FIG. 4, the apparatus may include means, such as the processing circuitry 22, the processor 24, the communication interface 28 or the like, for, based on network conditions, determining whether to provide indications for onloading or offloading.

As shown in block 404 of FIG. 4, the apparatus may include means, such as the processing circuitry 22, the processor 24, the communication interface 28 or the like, for providing an indication of a first threshold value and a second threshold value for facilitating an access network change in the UE. Referring to block 406 of FIG. 4, the apparatus may include means, such as the processing circuitry 22, the processor 24, the communication interface 28 or the like, for, providing one or more parameters when conditions to change the access network are not be based on radio conditions but, instead, on network load. For example, as discussed above, this may occur when conditions to change the access network are not be based on radio conditions but instead, for example, on load in the system and thus parameters may not actually be traditional radio measurements but information provided by the NW. In another example embodiment, this information may be priority/preference of NW selection, such as for example, which network the UE should use for data transmissions.

In a second system embodiment, an eNB may provide a single threshold value. The UE may be configured to then use the single threshold in an access network change process. As such, FIG. 5 shows an example process that may, in some embodiments, be executed by a UE while FIG. 6 shows an example process that may, in some embodiments, be executed by an example eNB. The example processes shown below allow various embodiments of the present invention to facilitate an access network change where a single threshold value is provided.

In an example high level embodiment, a single threshold value may be provided by an eNB, and provide an indication of a point that when reached by a measured parameter, a UE should continue to operate in or change to a first connection mode (e.g., a 3GPP connection mode) or a second connection mode (e.g., a WLAN connection mode). Returning back to FIG. 5, the operations performed by an apparatus 20, such as illustrated in FIG. 2, embodied by a UE are illustrated and will be hereinafter described.

As shown in block 502 of FIG. 5, the apparatus may include means, such as the processing circuitry 22, the processor 24, the communication interface 28 or the like, for receiving an indication of a single threshold value. As shown in block 504 of FIG. 5, the apparatus may include means, such as the processing circuitry 22, the processor 24, the communication interface 28 or the like, for causing measurement of a parameter. Similar to an embodiment discussed above, the parameter, or an indication of a value related thereto, may be received from, for example, an eNB. As such, the apparatus may include means, such as the processing circuitry 22, the processor 24, the communication interface 28 or the like, for receiving an indication of a value of the parameter. For example, this may be the case when conditions to change the access network may not be based on radio conditions but instead, for example, on load in the system such that parameters may not actually be traditional radio measurements but information provided by the network (NW).

In an instance in which the single threshold value is provided as or provides an indication of one of, for example, an offloading condition or an onloading condition (e.g., RSRP_offload or RSRP_onload), as shown in block 506 of FIG. 5, the apparatus may include means, such as the processing circuitry 22, the processor 24, the communication interface 28 or the like, for causing comparison of the parameter to the corresponding condition thereto. For example, if RSRP_offload is received as the single threshold value from the eNB, the parameter may be measured from the WLAN network and compared to the offload condition. A UE operating in the WLAN continues to do so. Whereas if RSRP_onload is received from the eNB, the parameter may be compared to the onload condition.

As shown in block 508 of FIG. 5, the apparatus may include means, such as the processing circuitry 22, the processor 24, the communication interface 28 or the like, for providing an indication of an access network change.

In an instance in which a single threshold value is provided and provides no indication of offloading or onloading, as shown in block 510 of FIG. 5, the apparatus may include means, such as the processing circuitry 22, the processor 24, the communication interface 28 or the like, for determining whether to change access networks by comparing the parameter to the single threshold value. For example, in an instance in which a measured parameter (e.g., RSRP) is less than the single threshold, the UE may change to or stay in WLAN. Whereas, in an instance in which the measured parameter is greater than or, for example, equal to, the single threshold, the UE may change to or stay in cellular.

Again, additionally or alternatively, in order to avoid frequent access network changes and possible loss of data, access network changes during transmission may be limited. As such, the UE may be configured to, as shown in block 512, determine if a previous system change was been outside a predefined time period, such as for example, 3 seconds ago. If the previous access network change was outside the predefined time, the UE may be configured to change access networks. Whereas, if the previous access network change was not more than the predefined time ago, the UE may be configured to return to, for example, block 504.

Referring now to FIG. 6, a flow chart is shown illustrating operations performed by the apparatus 20, such as shown in FIG. 2, embodied by an access point 12 or station 10, in accordance with an example embodiment of the present invention. The operations performed by an apparatus 20, such as illustrated in FIG. 2, embodied by an access point 12 or station 10 will be hereinafter described. Referring now to block 602 of FIG. 6, the apparatus may include means, such as the processing circuitry 22, the processor 24, the communication interface 28 or the like, for, based on network conditions, determining whether to provide indications for onloading or offloading.

Referring now to block 604 of FIG. 6, the apparatus may include means, such as the processing circuitry 22, the processor 24, the communication interface 28 or the like, for providing a single threshold value (e.g., RSRP_offload or RSRP_onload) depending on the cell conditions. The single threshold may be an indication of whether the eNB favors offloading or onloading. For example, if the cell is overloaded, the threshold as RSRP_offload is signaled to the UEs. Whereas, if the cell is not overloaded, the threshold as RSRP_onload may be signaled to the UEs.

Referring to block 606 of FIG. 6, the apparatus may include means, such as the processing circuitry 22, the processor 24, the communication interface 28 or the like, for, providing one or more parameters when conditions to change the access network are not be based on radio conditions but, instead, on network load. For example, as discussed above, this may occur when conditions to change the access network are not be based on radio conditions but instead, for example, on load in the system and thus parameters may not actually be traditional radio measurements but information provided by the NW. In another example embodiment, this information may be priority/preference of NW selection, such as for example, which network the UE should use for data transmissions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-40. (canceled)

41. An apparatus comprising at least one processor and at least one memory including computer program code, the at least one memory and the computer program code configured to, with the processor, cause the apparatus to at least:
receive indication of a first threshold value and a second threshold value, the first threshold value and the second threshold value configured to indicate threshold values of a particular parameter in a first access network and a second particular parameter in a second access network, respectively;
cause measurement of a current value of the particular parameter in the first access network and reception of a current value of the second particular parameter provided by the second access network, the current value of the particular parameter in the first access network being a first parameter value and the current value of the particular second parameter in the second access network being a second parameter value;
in an instance in which a condition exists where the first parameter value satisfies the first threshold value and the second parameter value satisfies the second threshold value, determine if the condition is met for a predetermined amount of time; and
in an instance in which the condition is met for the predetermined amount of time, cause an access network change.

42. The apparatus according to claim 41, wherein the at least one memory and the computer program code are further configured to, with the processor, cause the apparatus to:
prior to causing an access network change, determine if a previous access network change was outside a predefined time period; and
in an instance in which the previous network change was outside the predefined time period, cause the access network change.

43. The apparatus according to claim 41, wherein the at least one memory and the computer program code are further configured to, with the processor, cause the apparatus to:
in an instance in which the previous network change was not outside the predefined time period, causing prevention of the access network change.

44. The apparatus according to claim 41, wherein the particular parameter is one of power, load, resource allocation, or radio access network (RAN) thresholds.

45. A computer program product comprising at least one computer-readable storage medium having computer-executable program code instructions stored therein, the computer-executable program code instructions comprising program code instructions for:
receiving indication of a first threshold value and a second threshold value, the first threshold value and the second threshold value configured to indicate threshold values of a particular parameter in a first access network and a second particular parameter in a second access network, respectively;
causing measurement of a current value of the particular parameter in the first access network and reception of a current value of the second particular parameter provided by the second access network, the current value of the particular parameter in the first access network being a first parameter value and the current value of the particular parameter in the second access network being a second parameter value;
in an instance in which a condition exists where the first parameter value satisfies the first threshold value and the second parameter value satisfies the second threshold value, determining if the condition is met for a predetermined amount of time; and
in an instance in which the condition is met for the predetermined amount of time, causing an access network change.

46. The computer program product according to claim 45, wherein the computer-executable program code instructions further comprise program code instructions for:
prior to causing an access network change, determining if a previous access network change was outside a predefined time period; and
in an instance in which the previous network change was outside the predefined time period, causing the access network change.

47. The computer program product according to claim 46, wherein the computer-executable program code instructions further comprise program code instructions for:
in an instance in which the previous network change was not outside the predefined time period, causing prevention of the access network change.

48. The computer program product according to claim 46, wherein the particular parameter is one of power, load, resource allocation, or radio access network thresholds

49. A method comprising:
receiving indication of a first threshold value and a second threshold value, the first threshold value and the second threshold value configured to indicate threshold values of a particular parameter in a first access network and a second particular parameter in a second access network, respectively;
causing measurement of a current value of the particular parameter in the first access network and reception of a current value of the second particular parameter provided by the second access network, the current value of the particular parameter in the first access network being a first parameter value and the current value of the particular parameter in the second access network being a second parameter value;
in an instance in which a condition exists where the first parameter value satisfies the first threshold value and the second parameter value satisfies the second threshold value, determining if the condition is met for a predetermined amount of time; and
in an instance in which the condition is met for the predetermined amount of time, causing an access network change.

50. The method of claim 49, further comprising:
prior to causing an access network change, determining if a previous access network change was outside a predefined time period; and
in an instance in which the previous network change was outside the predefined time period, causing the access network change.

51. The method according to claim 49, further comprising:
in an instance in which the previous network change was not outside the predefined time period, causing prevention of the access network change.

52. The method according to claim 49, wherein the particular parameter is one of power, load, resource allocation, or radio access network thresholds.
